(19) United States
(12) Patent Application Publication
(10) Pub. No.: US 2010/0106776 A1
(43) Pub. Date: Apr. 29, 2010

(54) Communication message sorting method and communication message sorting apparatus

(75) Inventors: Hirokazu Iwakura, Kawasaki (JP); Ken Yokoyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/654,754

(22) Filed: Dec. 30, 2009

Related U.S. Application Data
(63) Continuation of application No. PCT/JP2007/064264, filed on Jul. 19, 2007.

(51) Int. Cl. G06F 15/173; G06F 15/16

(52) U.S. Cl. 709/203; 709/224; 709/227

(57) ABSTRACT

After a source address, a destination address, a source port number, and a destination port number are extracted from a communication message and a communication connection and the direction of the communication connection are specified, transmitted/received message amounts every a predetermined elapsed time are determined for each communication connection. Next, a correlation between communication connections is calculated by using the transmitted/received message amounts determined for each communication connection. A server group in which a communication connection group with a high correlation is established is specified and a multilevel system that includes specified servers is determined.

### CROSS-REFERENCE TO RELATED APPLICATION(S)

This application is a continuation of International Application No. PCT/JP2007/064264, filed on Jul. 19, 2007, the entire contents of which are incorporated herein by reference.

### FIELD

The embodiments discussed herein are directed to a communication message sorting apparatus that performs a process of sorting a communication message related to a multilevel system including a plurality of server devices in which a series of communication message groups is exchanged from communication messages obtained from a network.

### BACKGROUND

Conventionally, there is a technology for analyzing an operating condition of a computer system in a network based on a communication message flowing in the network. For example, Japanese Laid-open Patent Publication No. 2006-11683 discloses a technology in which a transaction model defining calling relationships of messages flowing in the network between servers and the transaction model is matched with the actual messages thereby analyzing an operating condition of a system.

Moreover, as illustrated in FIG. 19, there is a technology in which when multilevel systems in each of which communication messages are exchanged among a plurality of apparatuses such as a database server, an application server, and a web server are mixed in a network, only messages that are exchanged in the multilevel systems are sorted from among communication messages captured from the network for analyzing the operating condition of the multilevel systems.

The above technology is briefly explained with reference to FIG. 20. Information (for example, a server address, a communication protocol type, and a hierarchical structure) on a server group constituting a multilevel system is obtained from system architecture data and system operation and maintenance data, and sorting information for specifying the server group constituting the multilevel system is manually generated by using the obtained information. Then, a filtering is performed on the communication message group captured from the network using the generated sorting information, thereby sorting and accumulating communication messages in each multilevel system (for example, a multilevel system-1 or a multilevel system-2).

However, a conventional technology for monitoring an operating condition of a multilevel system may not surely specify multilevel systems mixed in a network.

In other words, if a long time has passed after generating sorting information for specifying a server group constituting a multilevel system, the actual server group constituting the multilevel system is not consistent with the sorting information in some cases, so that the server group constituting the multilevel system may not surely be specified.

Moreover, when a plurality of multilevel systems is mixed in a network, sorting information for specifying a server group constituting each multilevel system needs to be generated manually, which is time consuming and causes difficulty.

### SUMMARY

According to an aspect of an embodiment of the invention, a communication message sorting apparatus sorts a communication message related to a multilevel system including a plurality of server devices in which a series of communication message groups is exchanged from each communication message obtained from a network. The communication message sorting apparatus includes a communication-message-information extracting unit that extracts a source address, a destination address, a source port number, and a destination port number for each connection-type communication message obtained from the network; a communication-connection specifying unit that specifies each of communication connections established between the server devices based on the source address, the destination address, the source port number, and the destination port number extracted by the communication-message-information extracting unit, and specifies an input-output direction of the communication connections in each of the server devices based on a transmission direction of a connection request message corresponding to each of the communication connections; a transmitted/received message amount storing unit that determines a transmitted/received message amount transmitted/received in a predetermined unit of time for each of the communication connections specified by the communication-connection specifying unit, and stores determined transmitted/received message amount while correlating with a communication connection and the input-output direction of the communication connection for each of the server devices; a correlation calculating unit that extracts each transmitted/received message amount stored in a predetermined time for each of the communication connections from each transmitted/received message amount stored for each of the server devices by the transmitted/received message amount storing unit, and calculates a correlation between communication connections by using a transmitted/received message amount transmitted/received between the communication connections for each input-output combination of the communication connections in each of the server devices; and a multilevel system specifying unit that specifies server devices in which communication connections with a strong correlation that is calculated by the correlation calculating unit are established, and specifies a system that includes specified server devices as a multilevel system.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram for explaining an outline and characteristics of a communication message sorting apparatus according to a first embodiment;

FIG. 2 is a diagram for explaining an outline and characteristics of the communication message sorting apparatus according to the first embodiment;

FIG. 3 is a diagram for explaining an outline and characteristics of the communication message sorting apparatus according to the first embodiment;

FIG. 4 is a diagram for explaining an outline and characteristics of the communication message sorting apparatus according to the first embodiment;

FIG. 5 is a diagram for explaining an outline and characteristics of the communication message sorting apparatus according to the first embodiment;

FIG. 6 is a block diagram illustrating a configuration of the communication message sorting apparatus according to the first embodiment;

FIG. 7 is a diagram illustrating a configuration example of information stored in a communication-connection-information storing unit;

FIG. 8 is a diagram illustrating a configuration example of information stored in a message amount storing unit;

FIG. 9 is a diagram illustrating a configuration example of information stored in a correlation coefficient storing unit;

FIG. 10 is a diagram illustrating an example of determining a multilevel system;

FIG. 11 is a flowchart illustrating a flow of a transmitted/received message amount determining process according to the first embodiment;

FIG. 12 is a flowchart illustrating a flow of a multilevel system determining process according to the first embodiment;

FIG. 13 is a block diagram illustrating a configuration of a communication message sorting apparatus according to the second embodiment;

FIG. 14 is a diagram illustrating a configuration example of a sorting table according to the second embodiment;

FIG. 15 is a flowchart illustrating a flow of a sorting table generating process according to the second embodiment;

FIG. 16 is a flowchart illustrating a flow of a communication message sorting process according to the second embodiment;

FIG. 17 is a diagram illustrating an example of determining a multilevel system according to the second embodiment;

FIG. 18 is a diagram illustrating a computer that executes a communication message sorting program;

FIG. 19 is a diagram for explaining a conventional technology; and

FIG. 20 is a diagram for explaining the conventional technology.

### DESCRIPTION OF EMBODIMENTS

Preferred embodiments of the present invention will be explained with reference to accompanying drawings. In the following, as one embodiment of the communication message sorting program according to the present invention, a communication message sorting apparatus that executes the communication message sorting program is explained as a first embodiment, and thereafter other embodiments included in the present invention are explained.

### [a] First Embodiment

In the first embodiment, the outline and the characteristics of the communication message sorting apparatus according to the first embodiment and the configuration and the process of the communication message sorting apparatus are sequentially explained, and finally, the effect in the first embodiment is explained.

Outline and Characteristics of Communication Message Sorting Apparatus (First Embodiment)

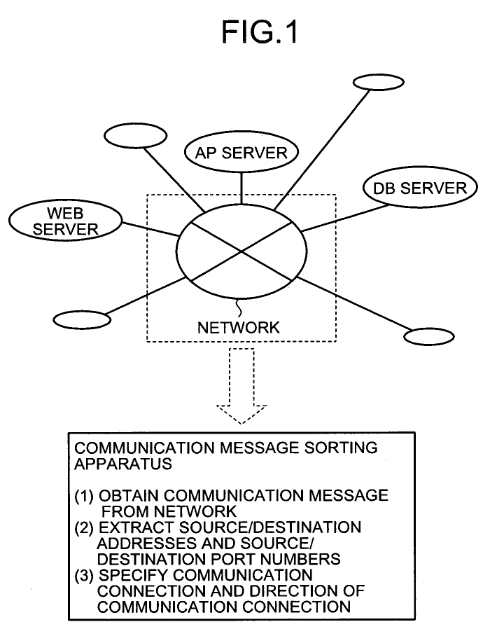

First, the outline and the characteristics of the communication message sorting apparatus according to the first embodiment are explained with reference to FIGS. 1 to 5. FIGS. 1 to 5 are diagrams for explaining the outline and the characteristics of the communication message sorting apparatus according to the first embodiment.

The communication message sorting apparatus according to the first embodiment is summarized in that a communication message related to a multilevel system including a plurality of server devices in which a series of communication message groups is exchanged is sorted from communication messages obtained from a network, and is mainly characterized in the point that a multilevel system can be easily specified in real time without performing a difficult operation for specifying the multilevel system.

To specifically explain this main characteristics, as illustrated in FIG. 1, the communication message sorting apparatus according to the first embodiment obtains a communication message continuously from the network (see (1) of FIG. 1) and checks whether the obtained communication message is a connection-type communication message. Specifically, a header of each obtained communication message is analyzed to check whether the obtained communication message is a communication message using a connection-type protocol (for example, TCP/IP).

The communication message that is checked as a connection type as a result of the check is further checked whether it is a connection request message. Specifically, the header of the communication message is analyzed to check whether the communication message is a communication message for a connection request.

When the communication message is a connection request message as a result of the check, a source address, a destination address, a source port number, and a destination port number are extracted from the communication message (see (2) of FIG. 1). Furthermore, a communication connection is specified based on the source address, the destination address, the source port number, and the destination port number that are extracted, and the direction (input-output direction of the communication connection in each server device) of the specified communication connection is specified (see (3) of FIG. 1).

Specifically, in a server as a source of the connection request message, the direction of the communication connection established by the connection request message becomes “output”, and in a server as a destination of the connection request message, the direction of the communication connection established by the connection request message becomes “input”. In the similar manner, all of the obtained communication messages are checked, and the communication connection and the direction of the communication connection are specified.

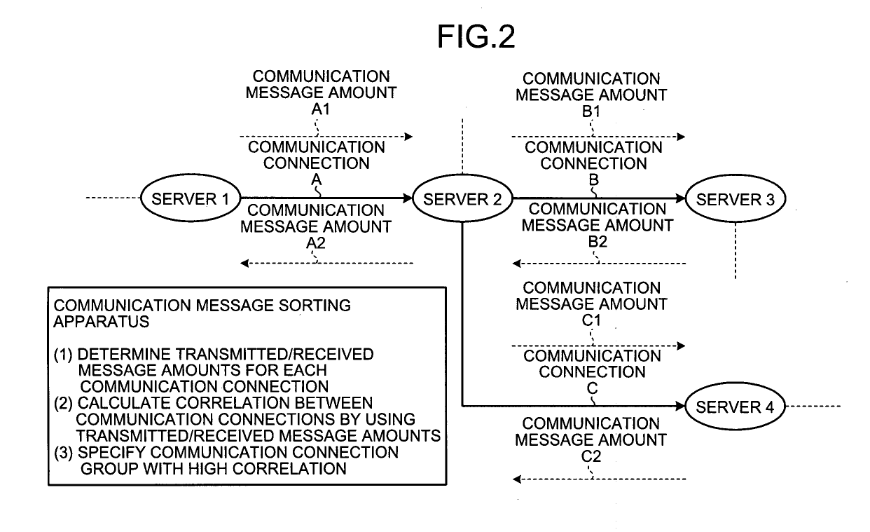

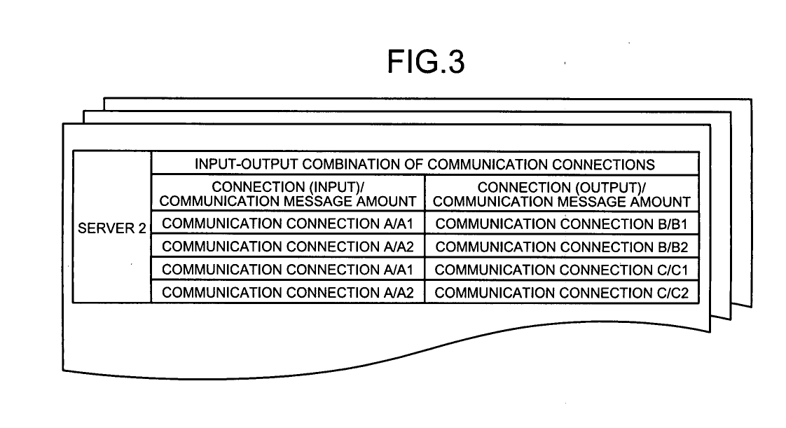

After the communication connection and the direction of the communication connection are specified, transmitted/received message amounts every predetermined elapsed time (for example, 100 msec) are determined for each communication connection (see (1) FIG. 2). For example, as illustrated in FIG. 2, a communication message amount transmitted/received within a predetermined time (for example, 1 sec) via a communication connection A is a communication message amount “A1” and a communication message amount “A2”. Then, as illustrated in FIG. 3, the determined transmitted/received message amounts are stored for each server while correlating with the communication connection and the input-output direction of the communication connection.

Subsequently, the communication message sorting apparatus according to the first embodiment calculates a correlation between communication connections by using the transmitted/received message amounts determined for each communication connection (see (2) of FIG. 2). Specifically, first, an input-output combination of the communication connections is calculated for each server. For example, in a server 2 illustrated in FIG. 2, three communication connections (communication connections “A”, “B”, and “C”) are established, and when the input-output combination of the communication connections, i.e., the combination in which the directions of the communication connections in the server 2 are “input” and “output”, is calculated, two pairs, i.e., the communication connection “A” and the communication connection “B”, and the communication connection “A” and the communication connection “C” present. In the similar manner, the input-output combination of communication connections is calculated for each server.

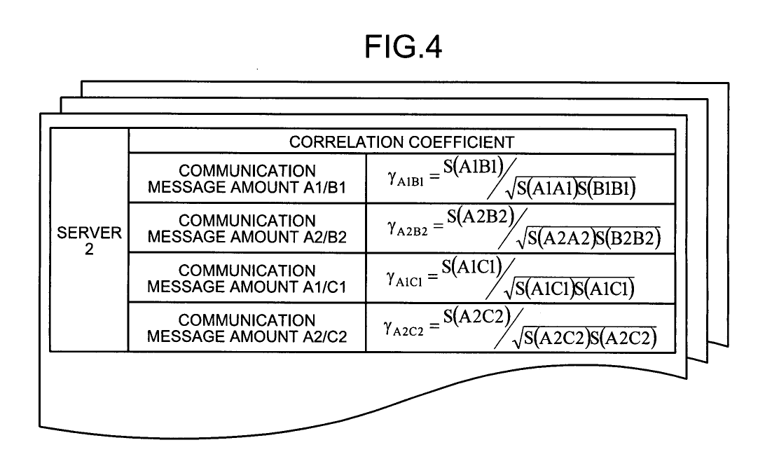

Next, a correlation between communication connections is calculated for each combination. Specifically, for example, as illustrated in FIG. 4, a correlation coefficient between the message amount “A1” received by the server 2 in the predetermined elapsed time via the communication connection “A” and a message amount “B1” transmitted from the server 2 in the predetermined elapsed time via the communication connection “B” and a correlation coefficient between a message amount “B2” received by the server 2 in the predetermined elapsed time via the communication connection “B” and the message amount “A2” transmitted from the server 2 in the predetermined elapsed time via the communication connection “A” are calculated.

Subsequently, the average value of the correlation coefficients is calculated, which is compared with a predetermined threshold, thereby specifying a communication connection group with a high correlation (see (3) of FIG. 2). Specifically, for example, when the average value of the calculated correlation coefficients is larger than the predetermined threshold (0.75), it is judged that the correlation between the communication connections is high. In the similar manner, the average value of correlation coefficients is calculated for each server, and a communication connection group with a high correlation is specified by tracing linkage of communication connections with a high correlation.

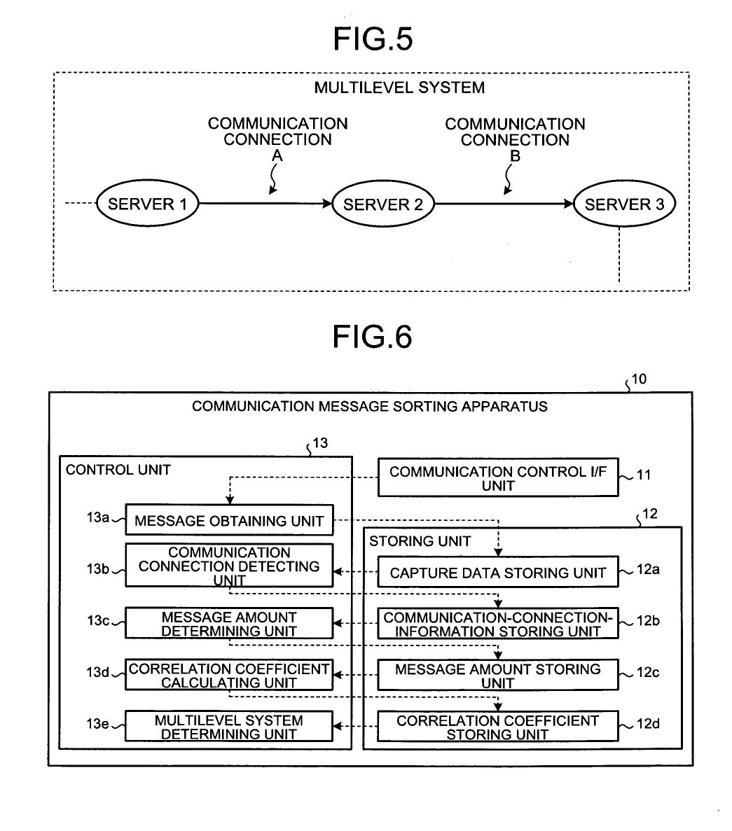

Then, a server group in which a communication connection group with a high correlation is established is specified to determine a multilevel system including specified servers. For example, as illustrated in FIG. 5, when it is possible to judge that the correlation between the communication connection “A” and the communication connection “B” is high, a server 1, the server 2, and a server 3 in which the communication connections “A” and “B” are established can be specified and a multilevel system including the server 1, the server 2, and the server 3 can be determined.

Accordingly, the communication message sorting apparatus according to the first embodiment can easily specify a multilevel system in real time without performing a difficult operation for specifying the multilevel system as the above-described main characteristics.

Configuration of Communication Message Sorting Apparatus (First Embodiment)

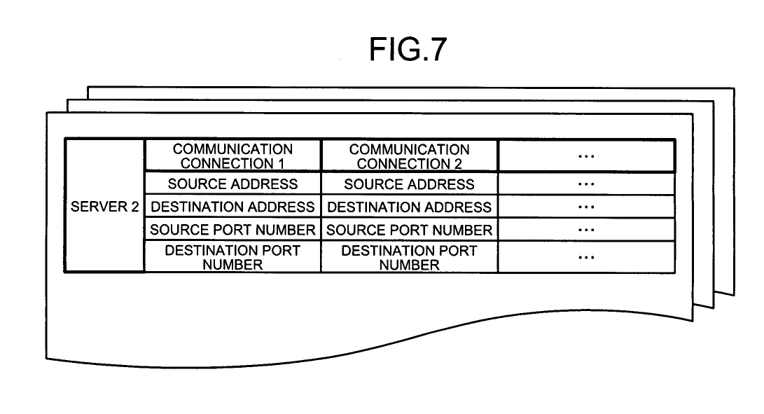

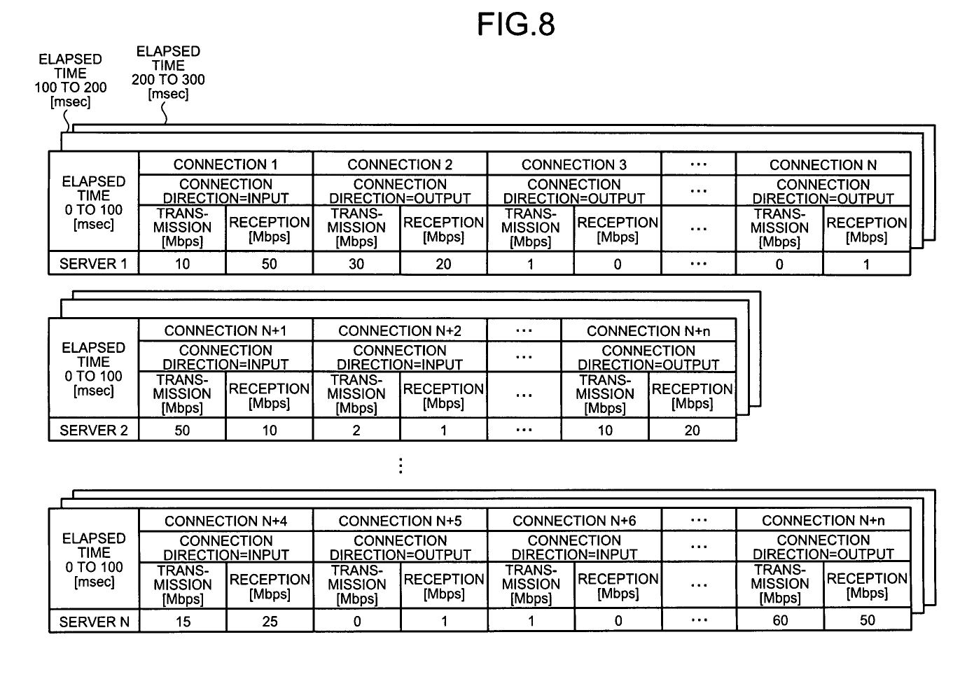

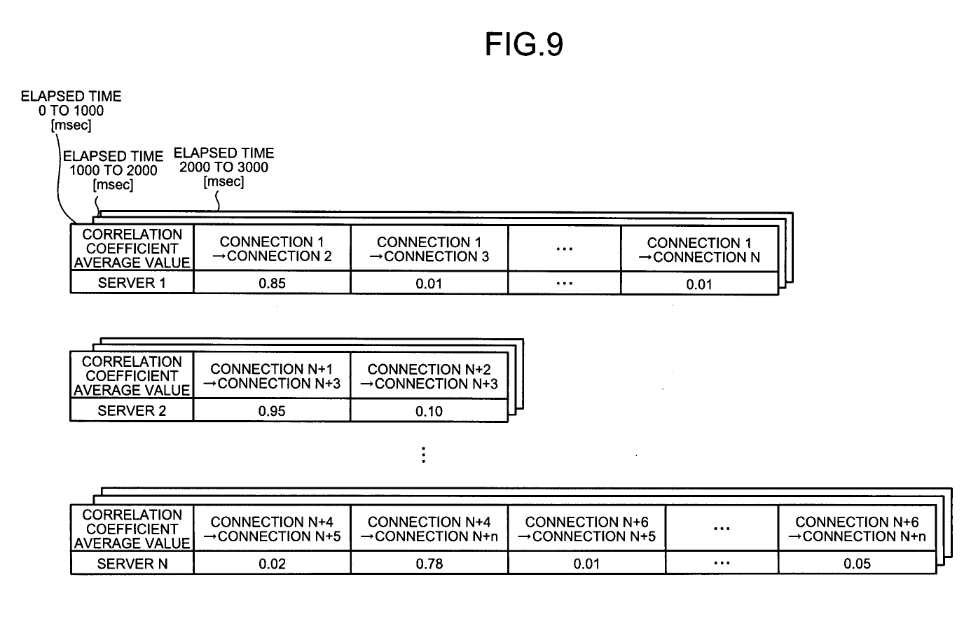

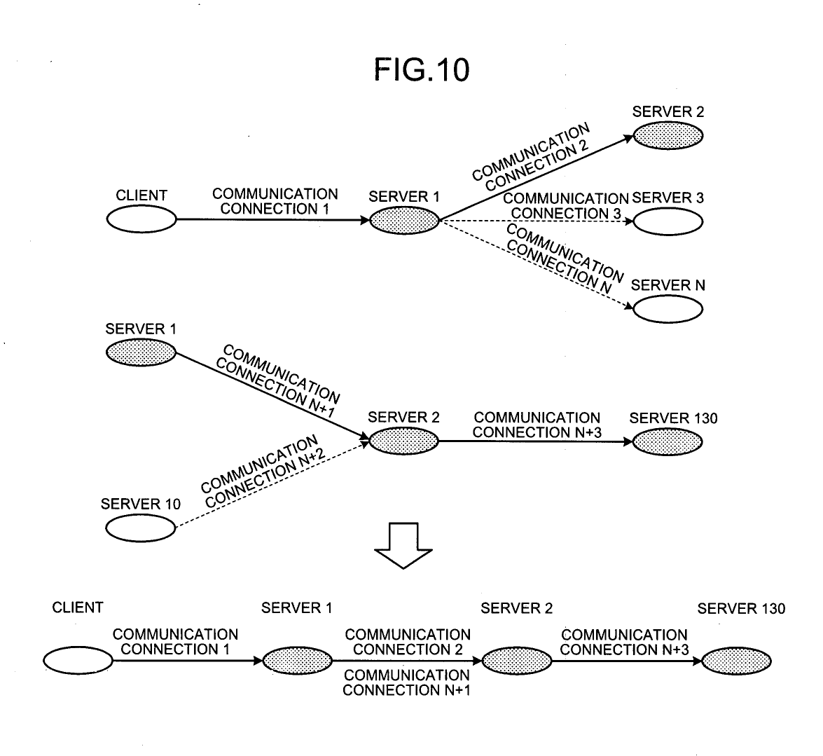

Next, a configuration of the communication message sorting apparatus according to the first embodiment is explained with reference to FIG. 6 to FIG. 10. FIG. 6 is a block diagram illustrating the configuration of the communication message sorting apparatus according to the first embodiment. FIG. 7 is a diagram illustrating a configuration example of information stored in a communication-connection-information storing unit. FIG. 8 is a diagram illustrating a configuration example of information stored in a message amount storing unit. FIG. 9 is a diagram illustrating a configuration example of information stored in a correlation coefficient storing unit. FIG. 10 is a diagram illustrating an example of determining a multilevel system.

As illustrated in FIG. 6, a communication message sorting apparatus 10 includes a communication control I/F unit 11, a storing unit 12, and a control unit 13.

The communication control I/F unit 11 controls the communication related to a capture of a communication message exchanged between servers via a network, and the like.

The storing unit 12 is a storing unit that stores therein data and a computer program necessary for various processes by the control unit 13, and includes a capture data storing unit 12a, a communication-connection-information storing unit 12b, a message amount storing unit 12c, and a correlation coefficient storing unit 12d as units particularly closely related to the present invention.

The capture data storing unit 12a is a storing unit that stores therein communication messages obtained (captured) from a network by a message obtaining unit 13a. The capture data storing unit 12a stores therein various information (a source address, a destination address, a source port number, a destination port number, and a communication message amount) of the captured communication message and the time at which the communication message is obtained in a correlated manner.

The communication-connection-information storing unit 12b is a storing unit that stores therein various information related to a communication connection specified by a communication connection detecting unit 13b. Specifically, as illustrated as an example in FIG. 7, the communication-connection-information storing unit 12b is configured by storing a source address, a destination address, a source port number, and a destination port number for specifying each communication connection established in each server for each server.

The message amount storing unit 12c is a storing unit that stores therein information about transmitted/received message amounts determined by a message amount determining unit 13c for each communication connection every predetermined elapsed time. Specifically, as illustrated as an example in FIG. 8, the message amount storing unit 12c is configured by storing a transmitted message amount and a received message amount while correlating with a communication connection (for example, the communication connection 1, 2, or 3) and the direction (“input” or “output”) of the communication connection every predetermined elapsed time (for example, 100 msec) for each server. Instead of storing the information about the communication message amounts determined every predetermined elapsed time (for example, 100 msec), for example, the communication message amounts determined every predetermined elapsed time can be combined in a predetermined time (for example, 1 sec) and stored.

The correlation coefficient storing unit 12d is a storing unit that stores therein a correlation coefficient of communication message amounts calculated by a correlation coefficient calculating unit 13d. Specifically, the correlation coefficient storing unit 12d is configured by storing the average value of the correlation coefficients of the communication message amounts calculated by the correlation coefficient calculating unit 13d between each communication connection combination (for example, the connection 1 to the connection 2) for each server.

The control unit 13 is a processing unit that includes an internal memory for storing a predetermined control program, a computer program defining various process procedures and the like, and required data, and performs various processes by these programs and the like stored in the internal memory. The control unit 13 includes the message obtaining unit 13a, the communication connection detecting unit 13b, the message amount determining unit 13c, the correlation coefficient calculating unit 13d, and a multilevel system determining unit 13e as units particularly closely related to the present invention.

The message obtaining unit 13a is a processing unit that obtains (captures) a communication message exchanged between servers from a network via the communication control I/F unit 11. The message obtaining unit 13a stores communication messages obtained from the network in a predetermined elapsed time in the capture data storing unit 12a while correlating with the time at which the communication messages are obtained.

The communication connection detecting unit 13b is a processing unit that specifies a communication connection and the direction of the communication connection based on a communication message obtained by the message obtaining unit 13a. Specifically, the communication connection detecting unit 13b sequentially reads out a communication message stored in the capture data storing unit 12a and checks whether the communication message is a connection-type communication message. More specifically, the communication connection detecting unit 13b analyzes the header of the obtained communication message, checks the type of the communication protocol used in the communication, and checks whether information indicating that the communication message is a communication message using a connection-type protocol (for example, TCP/IP) is stored.

For the communication message that is checked as a connection type as a result of the check, the communication connection detecting unit 13b further checks whether it is a connection request message. Specifically, the communication connection detecting unit 13b analyzes the header of the communication message and checks whether it is a communication message for a connection request. More specifically, the communication connection detecting unit 13b analyzes the header of the communication message and checks whether bit information indicating that it is a communication message for a connection request is stored.

When it is the connection request message as a result of the check, the communication connection detecting unit 13b extracts a source address, a destination address, a source port number, and a destination port number from the communication message. Furthermore, the communication connection detecting unit 13b specifies a communication connection based on the source address, the destination address, the source port number, and the destination port number that are extracted and specifies the direction (input-output direction of the communication connection in each server device) of the specified communication connection. More specifically, in a server as a source of the connection request message, the direction of the communication connection corresponding to the connection request message becomes “output”, and in a server as a destination of the connection request message, the direction of the communication connection corresponding to the connection request message becomes “input”. Servers that exchange the communication message are specified based on the source address, the destination address, the source port number, and the destination port number extracted from the communication message.

Then, the communication connection detecting unit 13b stores a source address, a destination address, a source port number, and a destination port number specifying each communication connection established in each server in the communication-connection-information storing unit 12b for each server (see FIG. 7).

The message amount determining unit 13c is a processing unit that determines transmitted/received message amounts every predetermined elapsed time for each communication connection specified by the communication connection detecting unit 13b. Specifically, the message amount determining unit 13c reads out communication messages corresponding to each communication connection specified by the communication connection detecting unit 13b from the communication messages stored in the capture data storing unit 12a and determines communication message amounts transmitted and received via each communication connection every predetermined elapsed time (for example, 100 msec).

Then, the message amount determining unit 13c stores the transmitted message amount and the received message amount determined every predetermined elapsed time in the message amount storing unit 12c while correlating with a communication connection (for example, the communication connection 1, 2, or 3) and the direction (“input” or “output”) of the communication connection for each server. The message amount determining unit 13c can determine the transmitted/received message amounts every predetermined elapsed time (for example, 1 msec) and store transmitted/received message amounts combined in a predetermined time (for example, 1 sec) for each server in the message amount storing unit 12c.

The correlation coefficient calculating unit 13d is a processing unit that calculates a correlation between communication connections by using the transmitted/received message amounts determined for each communication connection by the message amount determining unit 13c. Specifically, the correlation coefficient calculating unit 13d first calculates an input-output combination of communication connections for each server. For example, in the server 2 illustrated in FIG. 2, three communication connections (the communication connections “A”, “B”, and “C”) are established, and when the input-output combination of communication connections, i.e., the combination in which the directions of the communication connections in the server 2 are “input” and “output”, is calculated, two pairs, i.e., the communication connection “A” and the communication connection “B”, and the communication connection “A” and the communication connection “C” present. In the similar manner, the input-output combination of communication connections is calculated for each server.

Next, the correlation coefficient calculating unit 13d calculates a correlation between communication connections for each combination. First, the correlation coefficient calculating unit 13d reads out message amounts transmitted and received in a predetermined time from the message amount storing unit 12c for each communication connection.

Then, for example, in a case of an example illustrated in FIG. 4, the correlation coefficient calculating unit 13d calculates a correlation coefficient between the message amount “A1” received by the server 2 in a predetermined time via the communication connection “A” and the message amount “B1” transmitted from the server 2 in the predetermined time via the communication connection “B” and a correlation coefficient between the message amount “B2” received by the server 2 in the predetermined time via the communication connection “B” and the message amount “A2” transmitted from the server 2 in the predetermined time via the communication connection “A”, and calculates the average value of the correlation coefficients. In the similar manner, the correlation coefficient calculating unit 13d calculates the average value of correlation coefficients of communication message amounts for all of the servers and stored them in the correlation coefficient storing unit 12d.

For example, when the predetermined time for reading transmitted/received message amounts from the message amount storing unit 12c is set to 1 second, the correlation coefficient calculating unit 13d reads out 10 transmitted/received messages each determined every 100 msec for each communication connection and calculates a correlation coefficient by using the read transmitted/received message amounts for each server. In this manner, the setting of the elapsed time to read out message amounts transmitted and received from the message amount storing unit 12c for each communication connection can be appropriately changed.

The multilevel system determining unit 13e is a processing unit that specifies a communication connection group with a high correlation by using the average value of correlation coefficients calculated by the correlation coefficient calculating unit 13d. Specifically, first, the average value of correlation coefficients of communication message amounts calculated between each communication connection combination (for example, the connection 1 to the connection 2) is read out from the correlation coefficient storing unit 12d. Next, the average value read out for each server between each communication connection combination is compared with a predetermined threshold (for example, “0.75”). When the average value is large than the predetermined threshold, it is judged that the correlation between the communication connections is high. In the similar manner, the correlation between communication connections is checked for all of the servers, and a communication connection group with a high correlation is specified by tracing linkage of communication connections with a high correlation (see FIG. 9).

Then, the multilevel system determining unit 13e specifies a server group in which a connection group with a high correlation is established and determines a multilevel system including specified servers. Specifically, as illustrated in FIG. 10, when it is possible to judge that the correlation between a communication connection “1” and a communication connection “2” is high, a client (a source server of a connection request message), the server 1, and the server 2 in which the communication connections “1” and “2” are established are specified. Furthermore, when it is possible to judge that the correlation between a communication connection “N+1” and a communication connection “N+3” is high, the server 1, the server 2, and a server 130 in which the communication connections “N+1” and “N+3” are established are specified. Then, the specified servers are merged to determine a multilevel system including the client, the server 1, the server 2, and the server 130.

Process in Communication Message Sorting Apparatus (First Embodiment)

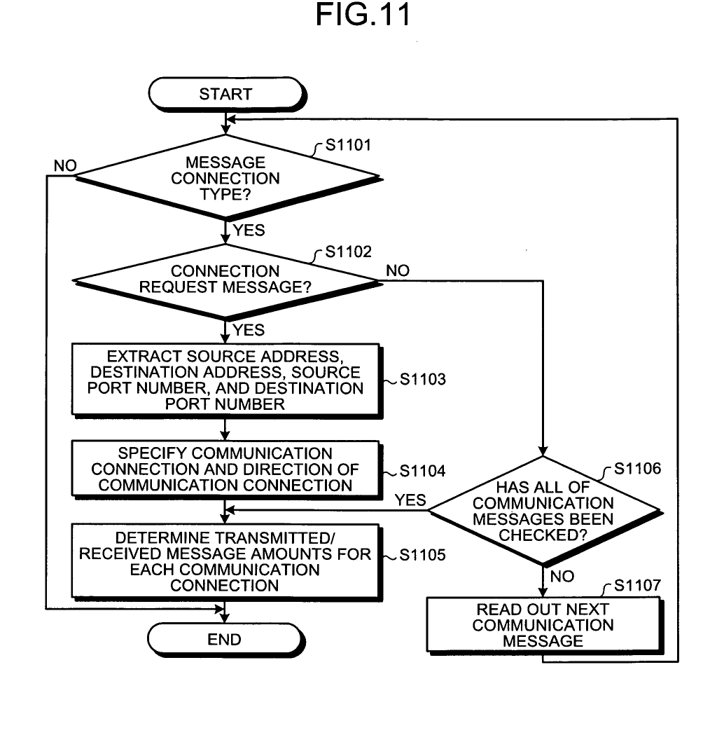

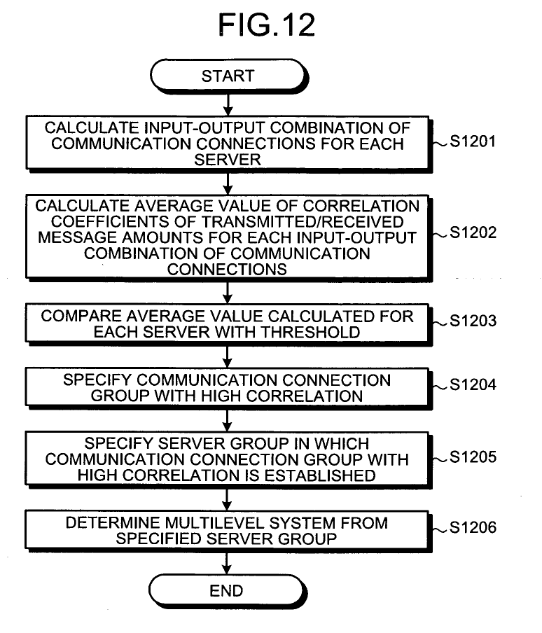

Subsequently, a process of the communication message sorting apparatus according to the first embodiment is explained with reference to FIG. 11 and FIG. 12. FIG. 11 is a flowchart illustrating a flow of a transmitted/received message amount determining process according to the first embodiment. FIG. 12 is a flowchart illustrating a flow of a multilevel system determining process according to the first embodiment.

Transmitted/Received Message Amount Determining Process

First, the flow of the transmitted/received message amount determining process according to the first embodiment is explained with reference to FIG. 11. As illustrated in FIG. 11, the communication connection detecting unit 13b sequentially reads out a communication message stored in the capture data storing unit 12a and checks whether the communication message is a connection-type communication message (Step S1101). Specifically, the communication connection detecting unit 13b analyzes the header of the obtained communication message, checks the type of the communication protocol used in the communication, and checks whether information indicating that the communication message is a communication message using a connection-type protocol (for example, TCP/IP) is stored.

When the communication message is checked as a connection type as a result of the check (Yes at Step S1101), the communication connection detecting unit 13b further checks whether the communication message is a connection request message (Step S1102). Specifically, the communication connection detecting unit 13b analyzes the header of the communication message and checks whether bit information indicating that the communication message is a communication message for a connection request is stored.

When the communication message is the connection request message as a result of the check (Yes at Step S1102), the communication connection detecting unit 13b extracts a source address, a destination address, a source port number, and a destination port number from the communication message (Step S1103).

Furthermore, the communication connection detecting unit 13b specifies a communication connection based on the source address, the destination address, the source port number, and the destination port number that are extracted and specifies the direction (input-output direction of the communication connection in each server device) of the specified communication connection (Step S1104). Then, the communication connection detecting unit 13b stores the source address, the destination address, the source port number, and the destination port number specifying each communication connection established in each server in the communication-connection-information storing unit 12b for each server (see FIG. 7).

Then, the message amount determining unit 13c determines transmitted/received message amounts for each communication connection specified by the communication connection detecting unit 13b (Step S1105). Specifically, the message amount determining unit 13c reads out communication messages corresponding to each communication connection specified by the communication connection detecting unit 13b from the communication messages stored in the capture data storing unit 12a and determines communication message amounts transmitted and received via each communication connection every predetermined elapsed time (for example, 100 msec). Then, the message amount determining unit 13c stores the transmitted message amount and the received message amount in the message amount storing unit 12c while correlating with a communication connection (for example, the communication connection 1, 2, or 3) and the direction (“input” or “output”) of the communication connection for each server.

Returning to the explanation at Step S1102, when the communication message checked as a connection type is not a connection request message (No at Step S1102), the communication connection detecting unit 13b judges whether it has already been checked for all of the communication messages stored in the capture data storing unit 12a whether the message is a connection type (Step S1106). As a result of the judgment, when the communication connection detecting unit 13b judges that it has already been checked for all of the communication messages stored in the capture data storing unit 12a whether the message is a connection type (Yes at Step S1106), the system control proceeds to the determination of the transmitted/received message amounts by the message amount determining unit 13c. On the other hand, when the communication connection detecting unit 13b judges that not all of the communication messages stored in the capture data storing unit 12a has been checked whether the message is a connection type (No at Step S1106), the communication connection detecting unit 13b reads out the next communication message from the capture data storing unit 12a (Step S1107)).

Multilevel System Determining Process

Next, the flow of the multilevel system determining process according to the first embodiment is explained with reference to FIG. 12. As illustrated in FIG. 12, the correlation coefficient calculating unit 13d first calculates an input-output combination of communication connections for each server (Step S1201). For example, in the server 2 illustrated in FIG. 2, three communication connections (the communication connections “A”, “B”, and “C”) are established, and when the input-output combination of the communication connections, i.e., the combination in which the directions of the communication connections in the server 2 are “input” and “output”, is calculated, two pairs, i.e., the communication connection “A” and the communication connection “B”, and the communication connection “A” and the communication connection “C” present. In the similar manner, the input-output combination of communication connections is calculated for each server.

Next, the correlation coefficient calculating unit 13d calculates the average value of correlation coefficients of transmitted/received message amounts for each input-output combination of the communication connections (Step S1202). Specifically, first, the correlation coefficient calculating unit 13d reads out message amounts transmitted and received in a predetermined elapsed time from the message amount storing unit 12c for each communication connection.

Then, for example, in a case of an example illustrated in FIG. 4, the correlation coefficient calculating unit 13d calculates a correlation coefficient between the message amount “A1” received by the server 2 in the predetermined elapsed time via the communication connection “A” and the message amount “B1” transmitted from the server 2 in the predetermined elapsed time via the communication connection “B” and a correlation coefficient between the message amount “B2” received by the server 2 in the predetermined elapsed time via the communication connection “B” and the message amount “A2” transmitted from the server 2 in the predetermined elapsed time via the communication connection “A”, and calculates the average value of the correlation coefficients. In the similar manner, the correlation coefficient calculating unit 13d calculates the average value of correlation coefficients of communication message amounts for all of the servers and stores them in the correlation coefficient storing unit 12d.

Subsequently, the multilevel system determining unit 13e reads out the average value of the correlation coefficients of the communication message amounts calculated between each communication connection combination (for example, the connection 1 to the connection 2) from the correlation coefficient storing unit 12d. Next, the average value read out for each server between each communication connection combination is compared with a predetermined threshold (for example, “0.75”) (Step S1203). When the average value is larger than the predetermined threshold (0.75), it is judged that the correlation between the communication connections is high. The correlation between communication connections is checked for all of the servers, and a communication connection group with a high correlation is specified by tracing linkage of communication connections with a high correlation. (Step S1204).

Then, the multilevel system determining unit 13e specifies a server group in which a connection group with a high correlation is established (Step S1205) and determines a multilevel system including specified servers (Step S1206).

Specifically, for example, as illustrated in FIG. 10, when it is possible to judge that the correlation between the communication connection “1” and the communication connection “2” is high, a client (a source server of the connection request message), the server 1, and the server 2 in which the communication connections “1” and “2” are established are specified. Furthermore, when it is possible to judge that the correlation between the communication connection “N+1” and the communication connection “N+3” is high, the server 1, the server 2, and the server 130 in which the communication connections “N+1” and “N+3” are established are specified. Then, the specified servers are merged to determine a multilevel system including the client, the server 1, the server 2, and the server 130.

Advantage of First Embodiment

As described above, according to the first embodiment, a source address, a destination address, a source port number, and a destination port number are extracted for each connection-type communication message obtained from a network, each communication connection established between server devices is specified based on the source address, the destination address, the source port number, and the destination port number that are extracted and a connection direction is specified from a transmission direction of a connection request message corresponding to each communication connection, a transmitted/received message amount transmitted and received in a predetermined unit of time is determined for each specified communication connection, the determined transmitted/received message amount is stored in a storing unit while correlating with a communication connection and the connection direction, each transmitted/received message amount stored in a predetermined time is extracted for each communication connection from each transmitted/received message amount stored in the storing unit, a correlation between communication connections is calculated by using a transmitted/received message amount transmitted and received between the communication connections for each input-output combination of the communication connections in each server device, server devices connected to a calculated communication connection group of which calculated correlation is strong are specified, and a system including specified server devices is specified as a multilevel system. Thus, a multilevel system can be easily specified in real time without performing a difficult operation for specifying the multilevel system.

Moreover, according to the present invention, each transmitted/received message amount stored in the predetermined time is extracted for each communication connection from each transmitted/received message amount stored in the storing unit for each server device, an average value of correlation coefficients between transmitted/received message amounts transmitted and received between communication connections is calculated for each input-output combination of the communication connections in each server device, it is judged whether the average value of the correlation coefficients calculated for each server device exceeds a predetermined threshold, a correlation between the communication connections that are judged that the average value exceeds the predetermined threshold is judged to be high, server devices in which the communication connections that are judged to have a high correlation are established are specified, and a system including specified server devices is specified as a multilevel system. Thus, a correlation between communication connections can be easily obtained from correlation coefficients calculated by using message' amounts of communication messages flowing in a network, and a multilevel system can be efficiently specified.

### [b] Second Embodiment

In the above first embodiment, a sorting table for sorting communication messages can be generated based on determined multilevel system and communication messages obtained from a network can be sorted for each multilevel system by using the generated sorting table. In the following, a configuration and a process of a communication message sorting apparatus according to a second embodiment are sequentially explained, and finally, the effect in the second embodiment is explained.

Configuration of Communication Message Sorting Apparatus (Second Embodiment)

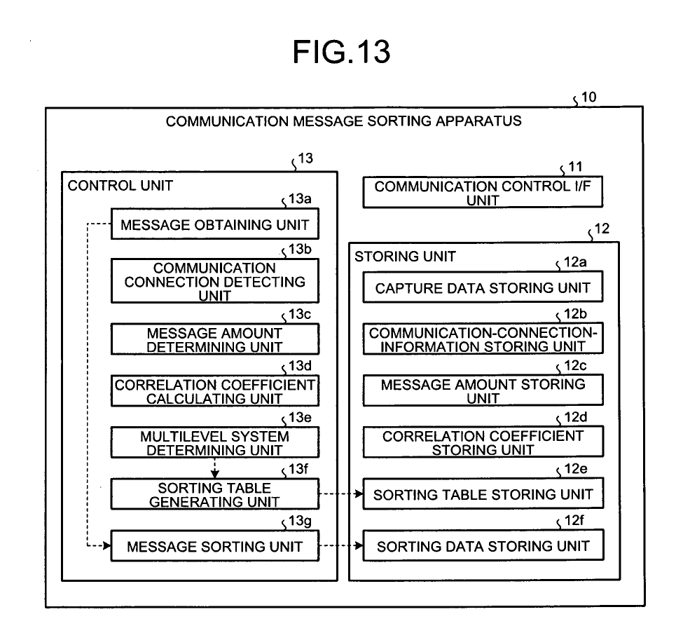

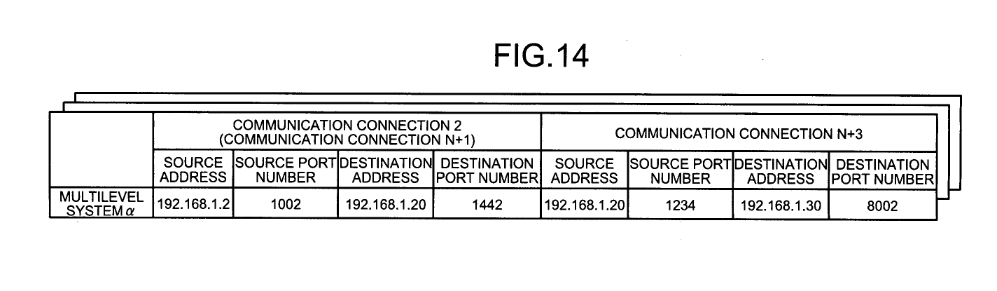

First, the configuration of the communication message sorting apparatus according to the second embodiment is explained with reference to FIG. 13 and FIG. 14. FIG. 13 is a block diagram illustrating the configuration of the communication message sorting apparatus according to the second embodiment. FIG. 14 is a diagram illustrating the configuration example of the sorting table according to the second embodiment. The communication message sorting apparatus according to the second embodiment is different from the communication message sorting apparatus according to the first embodiment in the following points.

That is, a sorting table storing unit 12e of the storing unit 12 is a storing unit that stores therein the sorting table generated by a sorting table generating unit 13f. Specifically, as illustrated in FIG. 14, the sorting table storing unit 12e is configured by storing information about each communication connection constituting a multilevel system, i.e., a source address, a source port number, a destination address, and a destination port number for each multilevel system.

A sorting data storing unit 12f of the storing unit 12 is a storing unit that stores therein communication messages sorted for each multilevel system by a message sorting unit 13g.

The sorting table generating unit 13f of the control unit 13 is a processing unit that generates the sorting table for sorting a communication message obtained by the message obtaining unit 13a for each multilevel system based on the multilevel system determined by the multilevel system determining unit 13e.

Specifically, the sorting table generating unit 13f extracts a communication connection established between servers included in each multilevel system for each multilevel system determined by the multilevel system determining unit 13e. Next, information corresponding to the extracted communication connection is read out from the communication-connection-information storing unit 12b, and a source address, a source port number, a destination address, and a destination port number are extracted for each communication connection. Then, the sorting table for each multilevel system is generated by organizing the source address, the source port number, the destination address, and the destination port number for each communication connection constituting a multilevel system, and the generated sorting tables are stored in the sorting table storing unit 12e.

The message sorting unit 13g of the control unit 13 is a processing unit that sorts a communication message obtained by the message obtaining unit 13a for each multilevel system and stores it. Specifically, the message sorting unit 13g reads out the sorting table of each multilevel system from the sorting table storing unit 12e and applies it as a filtering rule. Next, the message sorting unit 13g monitors the message obtaining unit 13a to obtain a communication message. When a communication message is obtained by the message obtaining unit 13a, the obtained communication message is sorted for each multilevel system by applying it to the filtering rule to be stored in the sorting data storing unit 12f.

Process in Communication Message Sorting Apparatus (Second Embodiment)

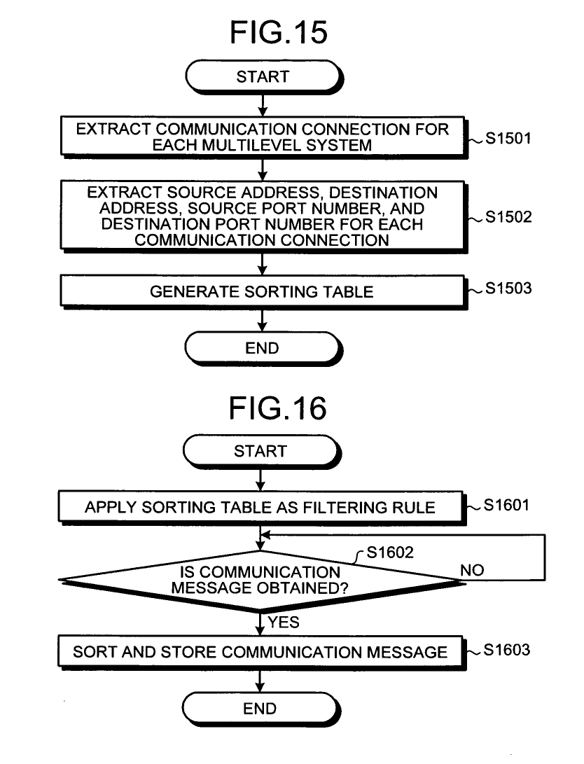

Subsequently, the process of the communication message sorting apparatus according to the second embodiment is explained with reference to FIG. 15 and FIG. 16. FIG. 15 is a flowchart illustrating a flow of a sorting table generating process according to the second embodiment. FIG. 16 is a flowchart illustrating a flow of a communication message sorting process according to the second embodiment.

Sorting Table Generating Process

First, the flow of the sorting table generating process according to the second embodiment is explained with reference to FIG. 15. As illustrated in FIG. 15, the sorting table generating unit 13f extracts a communication connection established between servers included in each multilevel system for each multilevel system determined by the multilevel system determining unit 13e (Step S1501).

Next, the sorting table generating unit 13f reads out information corresponding to the extracted communication connection from the communication-connection-information storing unit 12b and extracts a source address, a source port number, a destination address, and a destination port number for each communication connection (Step S1502). Then, the sorting table for each multilevel system is generated by organizing the source address, the source port number, the destination address, and the destination port number for each communication connection constituting a multilevel system (Step S1503), and the generated sorting tables are stored in the sorting table storing unit 12e.

Communication Message Sorting Process

Next, the flow of the communication message sorting process according to the second embodiment is explained with reference to FIG. 16. As illustrated in FIG. 16, the message sorting unit 13g reads out the sorting table of each multilevel system from the sorting table storing unit 12e and applies it as a filtering rule (Step S1601). Next, the message sorting unit 13g monitors the message obtaining unit 13a to obtain a communication message (Step S1602). When a communication message is obtained by the message obtaining unit 13a (Yes at Step S1602), the communication message obtained by the message obtaining unit 13a is applied to the filtering rule to be sorted for each multilevel system and is stored in the sorting data storing unit 12f (Step S1603).

Advantage of Second Embodiment

As described above, according to the second embodiment, a communication message sorting table including each communication connection established between servers included in a multilevel system, and a source address, a destination address, a source port number, and a destination port number corresponding to each communication connection is generated for each specified multilevel system, the generated communication message sorting table is stored in a storing unit, and a communication message related to a multilevel system is sorted from among communication messages flowing in a network by using the communication message sorting table stored in the storing unit. Thus, a load can be reduced by discarding communication messages not related to the multilevel system and the communication message related to the multilevel system can be sorted and accumulated.

In the second embodiment, explanation is given for the case of sorting a communication message by applying it to a filtering rule every time a communication message is obtained; however, the present invention is not limited thereto. It is also possible to accumulate obtained communication messages to some extent and thereafter sort the accumulated communication messages.

Moreover, as explained in the first embodiment, it is also possible to accumulate obtained communication messages until a multilevel system is determined from the obtained communication messages and sort the accumulated communication messages after the multilevel system is determined. Alternatively, it is also possible to continuously accumulate communication messages, regularly reexamine a multilevel system, and sort the communication messages in accordance with the latest condition of the multilevel system.

### [c] Third Embodiment

The first and second embodiments of the present invention are explained; however, the present invention can be embodied in various different forms other than the above described embodiments. In the following, other embodiments included in the present invention are explained.

(1) Determination of Multilevel System when Load Balancing Function is Applied Between Servers

For example, assuming that a load balancing function is applied between servers, it is possible that each transmitted/received message amount is extracted for each communication connection every predetermined elapsed time, the average value of correlation coefficients of the transmitted/received message amounts transmitted and received between the communication connections is calculated, it is judged every time the average value is calculated whether the average value exceeds a predetermined threshold, the correlation between the communication connections between which the average value of the correlation coefficients is judged to exceed the predetermined threshold in a certain period of time is judged to be high, servers in which the communication connections that are judged to have a high correlation are established are specified, and a system including specified server devices is specified as a multilevel system.

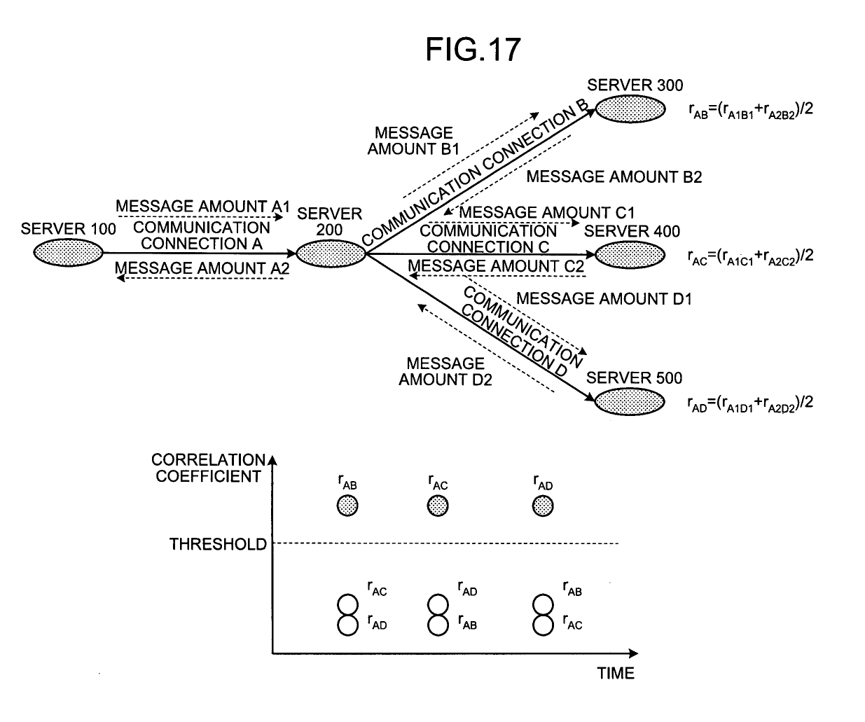

For example, as illustrated in FIG. 17, the correlation between communication connections AB, between communication connections AC, and between communication connections AD between which the average value of correlation coefficients is judged to exceed a predetermined threshold in a certain period of time is judged to be high, and a system including a server 100, a server 200, and a server 1300, a system including the server 100, the server 200, and a server 400, a system including the server 100, the server 200, and a server 500 are each specified as a multilevel system.

Accordingly, even when a load balancing function is applied between servers included in a multilevel system, the multilevel system can be specified by server devices specified from the same communication connection group.

(2) Apparatus Configuration and the Like

Each component in the communication message sorting apparatus illustrated in FIG. 6 or FIG. 13 is functionally and conceptually drawn, and is not necessarily formed physically in exactly the same manner as illustrated in the drawings. In other words, the specific form of division or integration of each communication message sorting apparatus is not limited to the one illustrated in the drawings. For example, the communication connection detecting unit 13b and the message amount determining unit 13c can be integrated, or the multilevel system determining unit 13e and the sorting table generating unit 13f can be integrated, i.e., all or part of the components thereof can be functionally or physically divided or integrated in arbitrary units to be configured according to various loads or the status of use. Furthermore, all or an arbitrary part of each process function (the transmitted/received message amount determining function, the multilevel system determining function, the sorting table generating function, the communication message sorting function, and the like) performed in each communication message sorting apparatus is realized by a central processing unit (CPU) and a computer program that is analyzed and executed by the CPU, or is realized as hardware by the wired logic.

(3) Communication Message Sorting Program

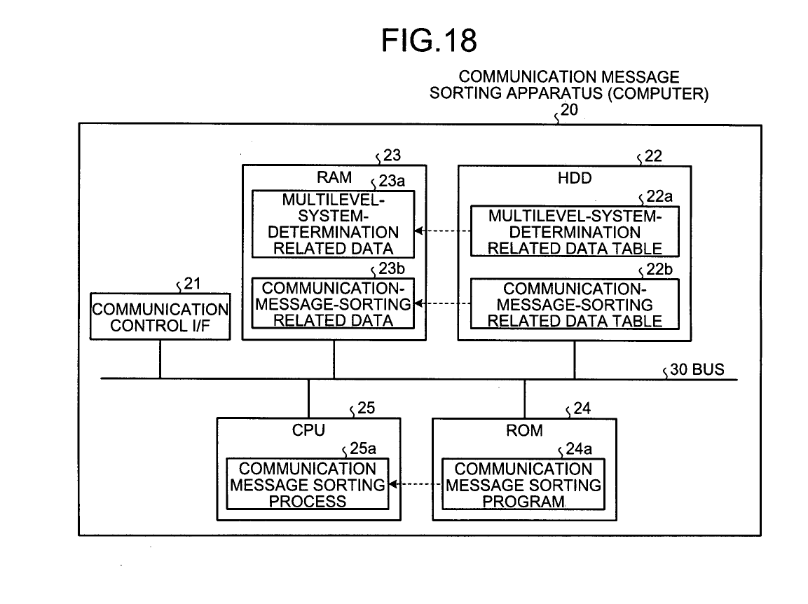

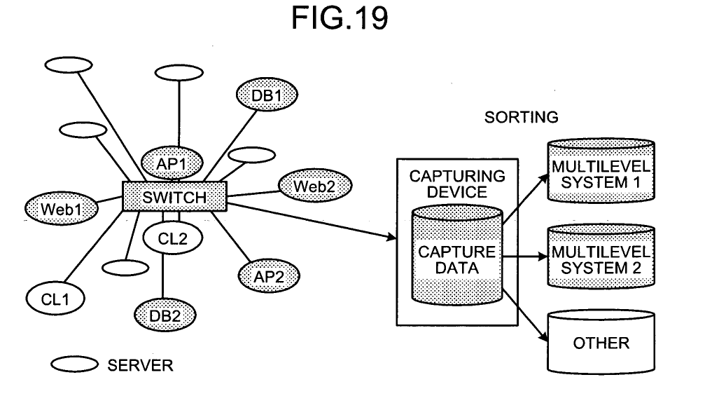

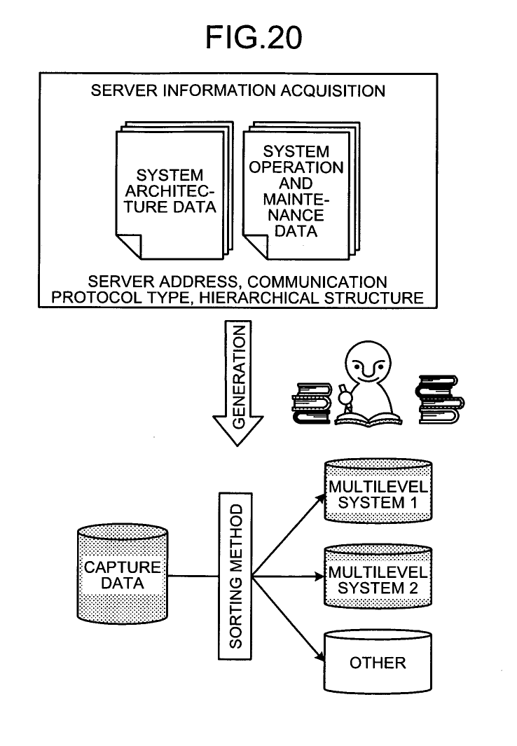

Various processes explained in the above embodiments (see FIG. 11, FIG. 12, FIG. 15, FIG. 16, and the like) can be realized by executing a computer program prepared in advance in a computer system such as a personal computer and a workstation. In the following, an example of a computer that executes a communication message sorting program including the similar function to the above embodiments is explained with reference to FIG. 18. FIG. 18 is a diagram illustrating a computer that executes the communication message sorting program.

As illustrated in FIG. 18, a computer 20 as the communication message sorting apparatus includes a communication control I/F 21, a hard disk drive (HDD) 22, a random access memory (RAM) 23, a read-only memory (ROM) 24, and a CPU 25, which are connected by a bus 30.

The ROM 24 stores therein a computer program that exerts the similar function to the communication message sorting apparatus in the above embodiments. In other words, as illustrated in FIG. 18, the ROM 24 stores therein a communication message sorting program 24a in advance. The communication message sorting program 24a can be appropriately integrated or divided similarly to each component of the communication message sorting apparatus illustrated in FIG. 6 or FIG. 13. The ROM 24 can be a nonvolatile RAM.

The CPU 25 reads out and executes the communication message sorting program 24a from the ROM 24, so that, as illustrated in FIG. 18, the communication message sorting program 24a functions as a communication message sorting process 25a. The communication message sorting process 25a corresponds to the message obtaining unit 13a, the communication connection detecting unit 13b, the message amount determining unit 13c, the correlation coefficient calculating unit 13d, the multilevel system determining unit 13e, the sorting table generating unit 13f, and the message sorting unit 13g of the communication message sorting apparatus illustrated in FIG. 6 and FIG. 13.

In the HDD 22, as illustrated in FIG. 18, a multilevel-system-determination related data table 22a and a communication-message-sorting related data table 22b are stored. The multilevel-system-determination related data table 22a and the communication-message-sorting related data table 22b correspond to the capture data storing unit 12a, the communication-connection-information storing unit 12b, the message amount storing unit 12c, the correlation coefficient storing unit 12d, the sorting table storing unit 12e, and the sorting data storing unit 12f illustrated in FIG. 6 and FIG. 13. The CPU 25 reads out a multilevel-system-determination related data 23a and a communication-message-sorting related data 23b from the multilevel-system-determination related data table 22a and the communication-message-sorting related data table 22b, respectively, stores them in the RAM 23, and executes a process based on the multilevel-system-determination related data 23a and the communication-message-sorting related data 23b stored in the RAM 23.

The communication message sorting program 24a needs not always be stored in the ROM 24 from the beginning. For example, each computer program can be stored in a “portable physical media” such as a flexible disk (FD), a compact disc read only memory (CD-ROM), a digital versatile disc (DVD), a magneto-optical (MO) disk, and an integrated circuit (IC) card that is inserted in the computer 20, a “fixed physical media” such as an HDD provided inside or outside of the computer 20, or a “different computer (or server)” connected to the computer 20 via a public line, the Internet, a local area network (LAN), a wide area network (WAN), or the like, and can be executed by the computer 20 reading out the computer program from such media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable storage medium having stored therein a communication message sorting program for causing a computer to perform a process of sorting a communication message related to a multilevel system including a plurality of server devices in which a series of communication message groups is exchanged from each communication message obtained from a network, the process comprising:
extracting a source address, a destination address, a source port number, and a destination port number for each connection-type communication message obtained from the network;
specifying each of communication connections established between the server devices based on the source address, the destination address, the source port number, and the destination port number extracted at the communication-message-information extracting;
specifying an input-output direction of the communication connections in each of the server devices based on a transmission direction of a connection request message corresponding to each of the communication connections;
determining a transmitted/received message amount transmitted/received in a predetermined unit of time for each of the specified communication connections;
storing determined transmitted/received message amount in a storing unit while correlating with a communication connection and the input-output direction of the communication connection for each of the server devices;
extracting each transmitted/received message amount stored in a predetermined time for each of the communication connections from each transmitted/received message amount stored in the storing unit for each of the server devices;
calculating a correlation between communication connections by using a transmitted/received message amount transmitted/received between the communication connections for each input-output combination of the communication connections in each of the server devices;
specifying server devices in which communication connections with a strong correlation calculated at the calculating are established; and
specifying a system that includes specified server devices as a multilevel system.

2. The computer readable storage medium according to claim 1, wherein
the extracting includes extracting each transmitted/received message amount stored in the predetermined time for each of the communication connections from each transmitted/received message amount stored in the storing unit for each of the server devices at the transmitted/received message amount storing,
the calculating includes calculating an average of correlation coefficients between transmitted/received message amounts transmitted/received between communication connections for each input-output combination of the communication connections in each of the server devices,
the process further comprises judging whether the calculated average of the correlation coefficients for each of the server devices exceeds a predetermined threshold,
the specifying server devices includes judging that a correlation between communication connections, which are judged that the average value exceeds the predetermined threshold at the judging, is high, and specifying server devices in which the communication connections that are judged to have a high correlation are established, and
the specifying a system as a multilevel system includes specifying a system that includes specified server devices as a multilevel system.

3. The computer readable storage medium according to claim 2, wherein
the extracting includes extracting each transmitted/received message amount stored in the storing unit for each of the server devices at the transmitted/received message amount storing every predetermined elapsed time for each of the communication connections,
the calculating includes calculating an average of correlation coefficients between transmitted/received message amounts transmitted/received between communication connections for each input-output combination of the communication connections in each of the server devices every time the each transmitted/received message amount is extracted,
the judging whether the average exceeds a predetermined threshold includes judging whether the average exceeds the predetermined threshold every time the average is calculated at the calculating, and
the judging that a correlation between communication connections is high includes judging that a correlation between communication connections, which are judged that the average value exceeds the predetermined threshold at the threshold judging in a certain period of time, is high, the specifying server devices includes specifying server devices in which the communication connections that are judged to have a high correlation are established, and
the specifying a system as a multilevel system includes specifying a system that includes specified server devices as a multilevel system.

4. The communication message sorting program according to claim 1, wherein the process further comprises:
generating a communication message sorting table including each of the communication connections established between the server devices included in a multilevel system, and a source address, a destination address, a source port number, and a destination port number corresponding to each of the communication connections for each multilevel system specified;
storing the communication message sorting table generated at the sorting table generating in the storing unit; and
sorting a communication message related to a multilevel system from among communication messages flowing in the network by using the communication message sorting table stored in the storing unit.

5. A communication message sorting method for sorting a communication message related to a multilevel system including a plurality of server devices in which a series of communication message groups is exchanged from each communication message obtained from a network, the communication message sorting method comprising:
extracting a source address, a destination address, a source port number, and a destination port number for each connection-type communication message obtained from the network;
specifying each of communication connections established between the server devices based on the source address, the destination address, the source port number, and the destination port number extracted at the communication-message-information extracting;
specifying an input-output direction of the communication connections in each of the server devices based on a transmission direction of a connection request message corresponding to each of the communication connections;
determining a transmitted/received message amount transmitted/received in a predetermined unit of time for each of the specified communication connections;
storing determined transmitted/received message amount in a storing unit while correlating with a communication connection and the input-output direction of the communication connection for each of the server devices;
extracting each transmitted/received message amount stored in a predetermined time for each of the communication connections from each transmitted/received message amount stored in the storing unit for each of the server devices;
calculating a correlation between communication connections by using a transmitted/received message amount transmitted/received between the communication connections for each input-output combination of the communication connections in each of the server devices;
specifying server devices in which communication connections with a strong correlation calculated at the calculating are established; and
specifying a system that includes specified server devices as a multilevel system.

6. A communication message sorting apparatus that sorts a communication message related to a multilevel system including a plurality of server devices in which a series of communication message groups is exchanged from each communication message obtained from a network, the communication message sorting apparatus comprising:
a communication-message-information extracting unit that extracts a source address, a destination address, a source port number, and a destination port number for each connection-type communication message obtained from the network;
a communication-connection specifying unit that specifies each of communication connections established between the server devices based on the source address, the destination address, the source port number, and the destination port number extracted by the communication-message-information extracting unit, and specifies an input-output direction of the communication connections in each of the server devices based on a transmission direction of a connection request message corresponding to each of the communication connections;
a transmitted/received message amount storing unit that determines a transmitted/received message amount transmitted/received in a predetermined unit of time for each of the communication connections specified by the communication-connection specifying unit, and stores determined transmitted/received message amount while correlating with a communication connection and the input-output direction of the communication connection for each of the server devices;
a correlation calculating unit that extracts each transmitted/received message amount stored in a predetermined time for each of the communication connections from each transmitted/received message amount stored for each of the server devices by the transmitted/received message amount storing unit, and calculates a correlation between communication connections by using a transmitted/received message amount transmitted/received between the communication connections for each input-output combination of the communication connections in each of the server devices; and
a multilevel system specifying unit that specifies server devices in which communication connections with a strong correlation that is calculated by the correlation calculating unit are established, and specifies a system that includes specified server devices as a multilevel system.
